(19) United States
(12) Patent Application Publication
(10) Pub. No.: US 2014/0222180 A1
(43) Pub. Date: Aug. 7, 2014

(54) BATCH CONVERSION

(71) Applicant: METTLER-TOLEDO, LLC, Columbus, OH (US)

(72) Inventor: Venus Simmons, Sunbury, OH (US)

(73) Assignee: METTLER-TOLEDO, LLC, Columbus, OH (US)

(21) Appl. No.: 13/757,605

(22) Filed: Feb. 1, 2013

(51) Int. Cl. G06F 17/00

(52) U.S. Cl. CPC G06F 17/00
USPC 700/97

(57) ABSTRACT

Batch conversion systems and methods by which residual ingredients from a previous product batch can be used in a subsequent product batch, with the required amount of ingredients in the subsequent batch being adjusted accordingly.

### TECHNICAL FIELD

The present invention is directed to batch processing and to systems and methods for applying leftover materials to subsequent batches.

### BACKGROUND

Batch manufacturing is widely used in a variety of industries, such as foodstuffs, pharmaceuticals and chemicals. Batch manufacturing differs from continuous manufacturing in that in the former, a given quantity of a particular product is passed through a specific manufacturing step and, once completed, the associated equipment is subsequently used to produce a new batch. In some cases, the associated equipment must be cleaned between batches. In other cases, more materials are simply provided and the process begins again. The materials used in the subsequent batch may be the same as or slightly different from the materials used in the previous batch.

Batch manufacturing (or batch production) usually proceeds according to a specific recipe. As a simplistic example, in the batch manufacturing of a foodstuff such as a baked good, a recipe typically defines exactly what ingredients are used and the quantity of each ingredient. The recipe also typically provides instructions on mixing, and downstream manufacturing steps such as the actual baking process, cooling, and possibly post-baking treatment. Recipes are, of course, not limited to use in the food industry.

It is not uncommon in batch manufacturing that a given batch of a product will use the same or substantially the same materials/ingredients as a previous batch. To continue with the baking example, if the product being made in batches is cookies, a second and additional subsequent cookie batches may use exactly the same ingredients as an initial batch. Alternatively, the ingredients that constitute the dough may be exactly the same, but chocolate chips may be replaced with peanut butter chips, raisins, etc. As another example, in chemical batch manufacturing, the ingredients of a subsequent paint batch may be identical except for the use of a different colorant.

In batch manufacturing, it is possible that some quantities of residual materials may remain in/with a given piece of manufacturing equipment after completion of a given manufacturing step. For example, some amount of the materials constituting a particular recipe may remain in a mixer after completion of a mixing step. These residual materials may be the result of a batch that was not completed, a partial batch, or other starting materials from previous processes (such as cleaning). Such residual materials may also be the result of an incomplete previous batch. Residual materials may be unintentionally left in/with a given piece of manufacturing equipment, such as when a mistake is made during batch production or when a user decides to make something different out of already existing materials. Residual materials may also be intentionally left in/with a given piece of manufacturing equipment, such as residual materials that result from a cleaning process or the materials of a partial supply batch that needs to be refilled.

While residual materials may sometimes be intentionally left in/with a given piece of manufacturing equipment, residual materials are also often removed and discarded so as not to alter the recipe governing the manufacture of a subsequent batch of product. As should be apparent, this can be extremely wasteful, as well as time consuming, especially if a subsequent product batch includes the same materials. It should also be therefore apparent that it would be desirable to make use of such residual materials when possible without simultaneously slowing down the manufacturing process. That is, if the recipe for a subsequent product batch calls for the same material(s) as the residual material(s), it would be desirable to incorporate the residual material(s) into the subsequent batch. If done properly, such an incorporation of materials not only reduces waste, but may also reduce the cycle time of the subsequent batch because the quantity of materials that must be supplied to a given piece of equipment to produce the subsequent batch is reduced.

While making use of such residual materials can be advantageous, it should be further apparent that any such advantage may be outweighed by an increased cycle time or complexity of the process if an operator is required to manually determine the amount of residual material and the percentages of each ingredient constituting the residual material, and to also appropriately alter the recipe for a subsequent product batch to account for the residual material. Consequently, what is truly desirable is a system and method that can apply a residual material to the recipe for a subsequent product batch in an automated or semi-automated fashion. Embodiments of the invention are such systems and methods.

### SUMMARY

Systems and methods of the invention allow a user to apply existing (e.g., residual) material towards a selected end recipe for a subsequent product batch. The existing material could potentially be from a batch that was not completed, a partial batch, or other starting materials from previous processes (such as cleaning) that can be used as part of the next batch.

Systems and methods of the invention compare the composition of the existing material to the composition of a selected recipe associated with a subsequent batch. The ingredient quantities of the recipe for the subsequent batch are then adjusted accordingly to account for the composition of the existing material. As described in more detail below, information about the composition of the existing material may be obtained in various ways, depending on whether the material results from an incomplete batch, a cleaning process, etc.

In some cases, systems and methods of the invention may employ an automatic process to calculate the amount of each ingredient present in an existing material. Such a process uses the weight of the existing material and information about the recipe used to produce the existing material to make such calculations. With the ratio of ingredients from the existing material recipe known, the resultant percentage of each may be multiplied by the starting material weight to determine the actual weight of each ingredient in the existing material. These amounts may then be subtracted from the weights of said ingredients called out in the recipe for the next product batch.

The amount of each ingredient required by the selected recipe for a new (subsequent) product batch is thus adjusted if some amount of the same ingredient is present in the existing material. More specifically, the amount of a given ingredient required by the selected recipe for a new (subsequent) product batch is reduced by the amount of that ingredient present in the existing material. The ingredients of the recipe for the existing material and the ingredients of the recipe for the new batch do not need to be identical. However, the existing material ingredients applied to the new batch either need to exist in the recipe for the new batch, or should be selected by the user to be ignored because they are insignificant to the new batch.

In other cases, such as when the existing material is associated with an incomplete previous batch, systems and methods of the invention cannot be used to automatically calculate the amounts of the individual ingredients present in the existing material because the system does not know how much of the previous batch was or was not completed. Consequently, in this case, a system of the invention must get information about the composition of the existing material from a user. To this end, a user may be prompted to select the recipe that the incomplete batch was based on, and to provide information on how much of the individual ingredients set out in the recipe are present in the existing material.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 schematically represents one exemplary embodiment of a system of the invention; and

FIG. 2 is a flow chart generally illustrating the steps associated with practicing an exemplary method of the invention.

### DETAILED DESCRIPTION OF EXEMPLARY EMBODIMENT(S)

As described above, systems and methods of the invention allow a user to apply existing (e.g., residual) material towards a selected end recipe for a subsequent product batch. The existing material could potentially be from a batch that was not completed, a partial batch, or other starting materials from previous processes (such as cleaning) that can be used as part of the next batch.

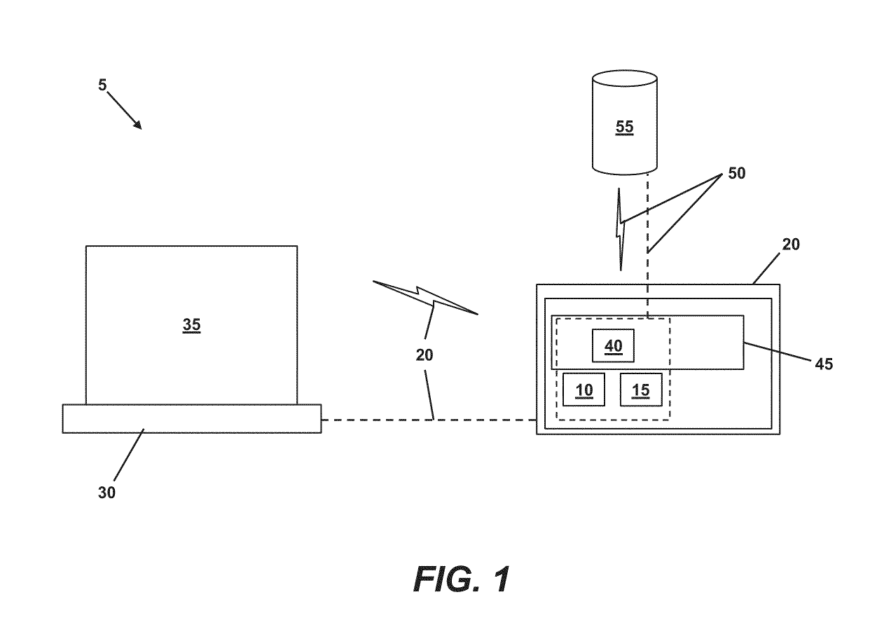

An exemplary embodiment of a system 5 of the invention is schematically illustrated in FIG. 1. As shown the exemplary system 5 includes a processor 10 in communication with an associated software program 15. Together, the processor 10 and the program 15 are operable to perform various batch conversion functions according to the invention. In the exemplary embodiment shown, the processor 10 and program 15 are parts of a weighing scale terminal 20, but could also be part of a batching or material transfer controller, etc. In one example, the weighing scale terminal may be a IND780 terminal available from Mettler-Toledo, LLC in Columbus, Ohio.

In the exemplary embodiment shown in FIG. 1, it can be seen that the terminal 20 may be in wired and/or wireless communication (as indicated by reference number 25) with a weighing scale 30. In this case, a container 35 rests on the scale 30, the container for receiving the ingredients of a product batch recipe. In some cases, the container 35 may be a permanent fixture whose weight is known and from which a material comprising the ingredients is removed, such as after a mixing step. In such a case, the program may be provided with the weight of the container 35 for use in calculating the weight of the actual material residing within the container. Alternatively, the container 35 may actually be one or more containers that are removed from the scale 30 after the ingredients of particular recipe are added thereto. In this case the weight of the container needs to be provided to the program at some point before the material weight calculation is performed. In still other cases, there may be no container.

The terminal 20 of this embodiment is also shown to include an interface, i.e., a human-machine-interface (HMI) 40, for permitting operator interaction with the terminal and the program 15. For example, the HMI 40 may permit a user to enter data regarding weights, material compositions, etc., and to access and possibly alter material recipes. The terminal 20 or other device may also include an integral or remote display 45 for conveying any of various information to a user.

The processor 10 and program 15 are in wired and/or wireless communication (as indicated by reference number 50) with a database of selectable product batch recipes 55. The database 55 may be resident at the terminal or may be located remotely therefrom. The database may be part of a PC application.

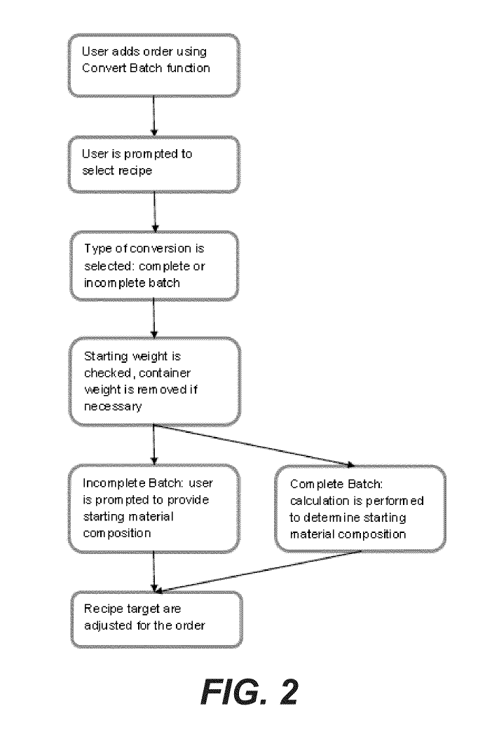

As discussed above, and generally indicated in FIG. 2, systems and methods of the invention compare the composition of an existing material (residing in the container 35, in this example) associated with a previous batch to the composition of a selected recipe associated with a subsequent batch to be created. Information about the composition of the existing material may be obtained in various ways, depending on whether the material results from a complete batch, an incomplete batch, a cleaning process, etc. For example, a user may select a recipe file associated with the previous batch produced, the cleaning material used, etc. Alternatively, the system may automatically extract composition information from a recipe file that was previously associated with the last batch.

In any case, the invention considers the weight of the existing material and information about the recipe used to produce the existing material to make such calculations. The invention may be in communication with a scale for purposes of determining material weight or a user may enter the material weight. For example, a container containing some amount of residual material may be placed on a scale that is in communication with the system, and the system may subtract a known weight of the container from the total weight of the container and residual material to determine the weight of the residual material. Alternatively, a user may enter the weight of the container into the system in the above scenario or, in yet another alternative method, the user may enter the weight or weigh percentage of one or more ingredients of the residual material into the system.

With the ratio of ingredients from the existing material recipe known, the resultant percentage of each may be multiplied by the starting material weight to determine the actual weight of each ingredient in the existing material. These amounts may then be subtracted from the weights of said ingredients called out in the recipe for the next product batch. More specifically, the amount of a given ingredient required by the selected recipe for a new (subsequent) product batch is adjusted by the amount of that ingredient present in the existing material.

### Complete Previous Batch

An adjustment amount must be calculated and then applied to the new recipe targets for each ingredient in a selected new material recipe. In the case of an existing material that results from a complete previous batch, systems and methods of the invention may employ an automatic process to calculate the amount of each ingredient present in an existing material and to determine and apply the necessary adjustments to the recipe for the newly selected material. The new recipe does not need to have identical ingredients to those in the existing material, however, the ingredients of the existing material to be applied to the new recipe either need to exist and, therefore, be adjusted, or should be selected by the user to be ignored (because they are insignificant to the batch). In any case, the program, in conjunction with the processor, is adapted to calculate a weight amount of each ingredient present in a known amount of an existing material and to accordingly adjust the weight amounts of the same ingredients required by a selected recipe for a new product batch to account for use of the existing material.

In the case of an existing material based on a complete previous batch, an exemplary automatic batch conversion process may proceed approximately as follows:

Calculate each material % in selected recipe
material %=Material target/Recipe target

Calculate material adjust_amount
material_adjust_amount=(Starting weight−container weight)×material %

Adjust new recipe by material_adjust_amount
New recipe adjusted material target=New recipe material Target−material_adjust_amount

### Incomplete Previous Batch

In other cases, such as when the existing material is associated with an incomplete previous batch, systems and methods of the invention cannot be used to automatically calculate the amounts of the individual ingredients present in the existing material because the system does not know how much of the previous batch was or was not completed. Consequently, in this case, a system of the invention must get information about the composition of the existing material from a user. To this end, a user may be prompted to select the recipe that the incomplete batch was based on, and to provide information on how much of the individual ingredients set out in the recipe are present in the existing material. These material values can be provided by weight or percent.

An exemplary user-assisted batch conversion process may proceed approximately as follows:

User selects existing material recipe

System provides material list with targets (% or weight values) and prompts user to adjust

User adjusts these values to match existing batch composition

Based on these values, system either uses or calculates existing material values (calculate material_adjust_amount)

System adjusts new recipe by material_adjust_amount

### EXAMPLES

### Example 1

A user batches into portable containers that are dosed out in other production areas. An existing partial batch material may remain in the container and must be accounted for at the start of the new batch. Recipe 1 is comprised of four ingredients: M1=250 kg, M2=100 kg, M3=100 kg, M4=50 kg. The ingredients are placed into a 205 kg tote. When the tote is returned for refilling, an amount of Recipe 1 material still resides in the tote.

According to the invention, a user places the tote on a scale (the scale reads 405 kg). If the user desires to refill the tote with the same exact recipe, an order can be created using normal rescaling methods. However in this example, the user wishes to convert the existing recipe to a similar recipe (Recipe 2) that has color additives. The composition of Recipe 2 is: M1=250 kg, M2=100 kg, M3=100 kg, M4=50 kg, M5=5 kg, M7=2.5 kg. In this case, the user is prompted by the system to select the recipe that was used to create the existing material (Recipe 1), asked if the Recipe 1 batch was completed, and then asked to select the recipe to which the existing recipe is to be converted (i.e., Recipe 2). In this example, the Recipe 1 batch was completed, so the user answers affirmatively to the corresponding prompt.

The user is then prompted to enter the weight of the container, if any (205 kg in this example). Since the remaining material was part of a completed batch, the system can automatically calculate the existing material amounts based on the existing material recipe without additional user information, as is described above. In this example, the existing material calculation proceeds as follows:

405−205=amount of actual batch material left over=200 kg

M1%=250/500=50%

M1 amount=200×0.50=100 kg

M2%=100/500=20%

M2 amount=200×0.20=40 kg

M3%=100/500=20%

M3 amount=200×0.20=40 kg

M4%=50/500=10%

M4 amount=200×0.10=20 kg

The Recipe 2 material new target calculations then proceed as follows:

M1=250−100=150 kg

M2=100−40=60 kg

M3=100−40=60 kg

M4=50−20=30 kg

M5=5−0=5 kg

M7=2.5−0=2.5 kg

### Example 2

A user runs a cleaning process that leaves water (and minimal miscellaneous residue material) in a material tank. The user wishes to use this water as part of next batch. In this example, the user runs a cleaning recipe (M10=50 kg), which adds 50 kg to an associated tank scale (the scale reads 49.9 kg). The user now wants to run Recipe 3, the composition of which is: M10=250 kg, M2=100 kg, M3=100 kg, M4=50 kg. There are two ways this can be accomplished—the user can either run a batch conversion operation based on the premise of a completed (cleaning) batch, run a batch conversion operation based on the premise of an incomplete previous (Recipe 3) batch.

Under the completed (cleaning) batch scenario, the user is prompted to select the recipe that was used to create the existing material (cleaning recipe), asked if the batch was completed (Yes, in this example), and then asked to select the recipe to be converted to (i.e., Recipe 3). The user is also prompted to enter the container weight, if any. Since the remaining existing material was part of a completed batch, the system can calculate the ingredient amounts based on the existing material recipe without additional user information. In this example, the existing material calculation proceeds as follows:

49.9−0=amount of actual batch material left over=49.9 kg

M10%=50/50=100%

M10 amount=49.9×1.0=49.9 kg

The Recipe 3 material new target calculations then proceed as follows:

M10=250−49.9=200.1 kg

M2=100−0=100 kg

M3=100−0=100 kg

M4=50−0=50 kg

Under the incomplete previous (Recipe 3) batch scenario, the user is prompted to select the recipe that was used to create the existing material (Recipe 3), asked if the batch was completed (No, in this case), and then asked to select the recipe to be converted to (Recipe 3). The user is also prompted to enter the container weight, if any. Since the remaining material was not part of a completed batch, the system prompts the user for information to calculate the ingredient amounts in the existing material. In this example, the existing material calculation proceeds as follows:

M10=??

M2=??

M3=??

M4=??

The user enters the required data. If done by %:

M10=100%

M2=0%

M3=0%

M4=0%

If done by value:

M10=49.9

M2=0

M3=0

M4=0

The system can then calculate the ingredient amounts based on the recipe.

49.9−0=amount of actual batch material left over=49.9 kg

M10%=100%

M10 amount=49.9×1.0=49.9 kg (if done by value, no calculation is needed)

The Recipe 3 material new target calculations then proceed as follows:

M10=250−49.9=200.1 kg

M2=100−0=100 kg

M3=100−0=100 kg

M4=50−0=50 kg

### Example 3

A user checks a batch after completion. Based on lab results, the user wished to adjust certain ingredient values by re-processing the batch and adding some ingredients. Recipe 1 is initially run and includes four materials: M1=250 kg, M2=100 kg, M3=100 kg, M4=50 kg, for a total of 500.0 kg. Lab tests are conducted. The lab test results indicate that the resultant batch needs an additional 1.5 kg of M1 (0.6%) and 0.5 kg of M4 (1%). The user could add this material by running Recipe 1 again after editing the targets (using the new numbers supplied by the lab), or the user could convert this batch by using the incomplete batch process.

Under the incomplete previous (Recipe 1) batch scenario, the user is prompted to select the recipe that was used to create the existing material (Recipe 1), asked if the batch was completed (No, in this case), and then asked to select the recipe to be converted to (Recipe 1). The user is also prompted to enter the container weight, if any. Since the remaining material was not part of a completed batch, the system prompts the user for information to calculate the existing material ingredient amounts. In this example, the existing material calculation proceeds as follows:

M1=??

M2=??

M3=??

M4=??

The user enters the required data. If done by %:

M1=99.4%

M2 =100%

M3=100%

M4=99%

If done by value:

M1=248.5

M2=100

M3=100

M4=49.5

The system can then calculate the ingredient amounts based on the existing material recipe.

500−0=amount of actual batch material left over=500 kg

M1%=99.4%

M1 amount=250×0.994=248.5 kg (if done by value, no calculation is needed)

M2 amount=100×1.0=100

M3 amount=100×1.0=100

M4 amount=50×0.99=49.5

The Recipe 1 material new target calculations then proceed as follows:

M1=250−248.5=1.5 kg

M2=100−100=0 kg

M3=100−100=0 kg

M4=50−49.5=0.5 kg

A number of general limitations associated with the invention should be followed. For example: the recipe target cannot be zero; the recipe adjustment should always reduce the amount of material in the recipe targets; increases should be handled by normal rescaling functions; if the existing material amount exceeds the new required amount, the user must decide whether the recipe targets should be adjusted by skipping this material (not adding any) or by rescaling the rest of the batch so that the material ratios of the recipe remain accurate for the new batch; if a material exists in the starting batch that is not required in the new batch, the user should be warned and make the choice whether to continue and make the new batch (because the additional materials do not “matter”) or to cancel the convert batch process; reporting features should include information about the starting batch (and its recipe), the starting amount, and the adjustment to the targets; special material handling processes are not taken into account (for example, mixing as materials are added) and it is up to the user to ensure that running the converted recipe is appropriate and will not cause unsafe or undesired results; and material path identities may cause issues with material identification in the recipes (especially those using manual material transfers). If several material paths can be used for the same material, a process to identify/confirm material mismatches between existing and converted recipes may be required.

While certain embodiments of the present invention are described in detail above, the scope of the invention is not to be considered limited by such disclosure, and modifications are possible without departing from the spirit of the invention as evidenced by the following claims:

What is claimed is:

1. A system for performing batch conversion, comprising:
a processor;
a database of selectable product batch recipes in communication with the processor;
a software program associated with the processor and in communication with the database of product batch recipes, the program adapted to calculate, in conjunction with the processor, a weight amount of each ingredient present in a known amount of an existing material and to accordingly adjust the weight amounts of the same ingredients required by a selected recipe for a new product batch to account for use of the existing material; and
an interface for permitting user interaction with the program.

2. The system of claim 1, wherein the processor and software program are part of a weighing scale terminal.

3. The system of claim 1, wherein a weighing scale is adapted to weigh the existing material and to automatically report the weight of the existing material to the software program.

4. The system of claim 1, wherein the software program is adapted to permit a user to identify whether the existing material is the result of a complete or incomplete previous batch.

5. The system of claim 4, wherein the software program is further adapted to prompt the user for information on the composition of the existing material in the case of an incomplete previous batch, and to use the information provided by the user to calculate the adjustments to the ingredients required by the selected recipe for the new product batch.

6. The system of claim 1, wherein the software program is adapted to account for the weight of a container within which the existing material resides.

7. The system of claim 1, wherein the software program is adapted to prompt a user to enter the weight of a container within which the existing material resides.

8. A method for automatically performing batch conversion using residual material from a complete previous batch, comprising:
identifying the composition of the residual material;
determining the total weight of the residual material;
calculating the weight of each ingredient in the residual material by multiplying the total weight of the residual material by the percentage of each ingredient that is expected to be present in the residual material according to a recipe for the residual material;
subtracting the calculated weight of each ingredient present in the residual material from the amount of each like ingredient called for in a recipe for the next product batch to be made; and
reducing the amount of a given ingredient called for by the recipe for the next product batch by the amount of that ingredient present in the residual material.

9. The method of claim 8, wherein the calculating, subtracting and reducing steps are performed by a processor in conjunction with a software program.

10. The method of claim 9, wherein the software program is in communication with a database of product batch recipes.

11. The method of claim 9, further comprising providing a user interface that permits user interaction with the program.

12. The method of claim 9, wherein a user is prompted by the program to select the recipe that was used to create the previous batch from which the residual material resulted, asked if the previous batch was completed, and then asked to select the recipe to which the existing recipe is to be converted.

13. The method of claim 9, wherein a user is prompted by the program to enter the weight of a container within which the residual material resides.

14. The method of claim 9, wherein the weight of the residual material is automatically reported to the software program by a weighing scale.

15. The method of claim 9, wherein the processor and software program are part of a weighing scale terminal.

16. A method for automatically performing batch conversion using residual material from an incomplete previous batch, comprising:
requesting from a user, identifying information regarding the residual material;
requesting from the user, identifying information regarding the the next product batch to be made;
requesting from the user, the amount of each ingredient present in the residual material;
calculating the amount of each ingredient present in the residual material using the ingredient information provided by the user;
subtracting the calculated weight of each ingredient present in the residual material from the amount of each like ingredient called for in the recipe for the next product batch to be made; and
reducing the amount of a given ingredient called for by the recipe for the next product batch by the amount of that ingredient present in the residual material.

17. The method of claim 16, wherein the calculating, subtracting and reducing steps are performed by a processor in conjunction with a software program.

18. The method of claim 17, wherein the software program is in communication with a database of product batch recipes.

19. The method of claim 17, further comprising providing a user interface that permits user interaction with the program.

20. The method of claim 17, wherein a user is prompted by the program to enter the weight of a container within which the residual material resides.

21. The method of claim 17, wherein the weight of the residual material is automatically reported to the software program by a weighing scale.

22. The method of claim 17, wherein the processor and software program are part of a weighing scale terminal.
